(19) United States
(12) Patent Application Publication
(10) Pub. No.: US 2007/0061110 A1
(43) Pub. Date: Mar. 15, 2007

(54) System and method for diagnosis based on set operations

(75) Inventors: Siamak Tafazoli, Montreal (CA); Xuehong Sun, Verdun (CA)

Correspondence Address: ROBIC, CENTRE CDP CAPITAL, 1001, VICTORIA SQUARE - BLOC E - 8TH FLOOR, MONTREAL, QC, H2Z 2B7, CA

(73) Assignee: CANADIAN SPACE AGENCY

(21) Appl. No.: 11/517,383

(22) Filed: Sep. 8, 2006

Related U.S. Application Data
(60) Provisional application No. 60/715,164, filed on Sep. 9, 2005.

(51) Int. Cl. G06F 11/30

(52) U.S. Cl. 702/183

(57) ABSTRACT

A method and system for obtaining a most likely diagnosis in a physical system having n components, a set of inputs, and a set of outputs. The method and system belong to model-bases diagnosis and use set operations for inference.

### FIELD OF THE INVENTION

The present invention relates to a system and method for diagnosing a physical system generally belonging to model-based diagnosis.

### BACKGROUND OF THE INVENTION

Humans will continue to forge ahead exploring the mysteries of space. This exploration will progress from near Earth missions to deep space which necessitates increase in on-board autonomy for the spacecraft as per the following reasons: (1) for deep space exploration, the communication delays between the spacecraft and ground are prohibitively long; and (2) for a large number of small spacecraft (e.g. formation flying mission), it is costly to depend solely on ground for their control and maintenance. On-board autonomy can perform such task as planning, scheduling, fault diagnosis and autonomous self-reconfiguration. This will not only reduce costs of ground operations and hence the overall mission costs, but will also be an enabling technology for future missions that require some tasks to be performed autonomously and in real-time.

NASA is leading the way in developing autonomous space systems. They have developed the Remote Agent which is an AI system combining high-level planning and scheduling, intelligent execution and the Livingstone model-based autonomous system kernel. Remote Agent allows the spacecraft to be able to explore, command, diagnose and repair themselves. This technology has been tested on the New Millennium Deep Space One spacecraft launched on Oct. 24, 1998.

At the heart of Remote Agent is the Livingstone system which has the Mode Identification (MI) module to reason the states of the spacecraft. All the planning, scheduling and fault diagnosis tasks are based on the results of the MI module which also helps correctly re-configure the spacecraft. Experiments show that Livingstone uses about 100 KB of memory and takes seconds to execute in case of a propulsion system.

The theory behind Livingstone is based on General Diagnosis Engine (GDE), which aims to find all possible diagnoses. In theory, GDE aims at tracking all state trajectories (the diagnosis is exhaustive, given a symptom). On the other hand, Livingstone only tracks several most possible states using a conflict directed best first search. This means that not all of the possible states are tracked. Indeed, GDE is computationally too intensive for state identification in spacecraft subsystem diagnosis. Though in practical application, approximation techniques such as focused searches are adopted, the computational complexity underlying GDE still persists.

Referring to FIG. 1, there is shown a system consisting of three Multipliers M₁, M₂, M₃ and two Adders A₁ A₂ that is used to exemplify the GDE, where A, B, C, D and E are input terminals, F and G are output terminals, and X, Y and Z are internal probe points. As required in GDE, in addition to this structure model, the behavior model of each components (multipliers and adders) are also needed. GDE uses both the structural and behavior model of the system for diagnosis. The structural model, which consists of logic formulae, tells GDE how the components of the system are interconnected. The behavior model, which also consists of logic formulae, specifies the inputs and outputs relationship of each component. Given symptoms observed, GDE uses logical inference to deduce diagnosis based on the structural and behavior model of the system. Thus, the GDE inference is triggered by symptoms. A symptom is defined as any difference between a prediction made by the inference procedure and an observation.

Considering the example in FIG. 1, one has this scenario: given A=3, B=2, C=2, D=3, and E=3, and one observes F=10 and G=12. By simple calculation (i.e. the inference procedure), X=6, Y=6, and F=X+Y=(A×C)+(B×D)=12. Therefore, “F is observed to be 10, not 12” is a symptom. With the symptom, GDE will give a set of diagnosis through the inference procedure. A diagnosis is a set of components assumed faulty (all the other components are assumed not faulty), which will explain the symptom. For example, {A₁ is faulty} (denoted as {AB(A₁)} which means A₁ is abnormal) is a diagnosis, because it explains: if A₁ is faulty and all other components are good, it makes sense that F=10 rather than F=12; on the other hand, {AB(A₂)} is not a diagnosis, because only A₂ is faulty does not explain why F=10. For this example, GDE gives the following four diagnoses: {AB(M₁)}, {AB(A₁)}, {AB(M₂), AB(A₂)}, {AB(M₂), AB(M₃)}. Let's explain why {AB(M₂), AB(A₂)} is considered a diagnosis. M₂ is faulty such that Y=4 (rather than 6), therefore F=X+Y=6+4=10. On the other hand, A₂ is faulty and happens to make Y+Z=G−2 (rather than G), therefore G=Y+Z+2=4+6+2=12. Putting it otherwise in words, both M₂ and A₂ are faulty, however their effect on G happens to cancel out. The same argument goes for {AB(M₂), AB(M₃)}. Let's leave the theory and come to real life. In real life applications, the probability of a component to be faulty is rather low (say 0.01). If one assumes the fault events among components are independent, then the probability that two components are simultaneously faulty is negligible (0.0001). Since a component can be faulty in various ways, the probability that the effects of two faulty components are cancelled out is significantly small (special care can be taken if this is not the case).

It needs to be pointed out that though GDE gives exhaustive diagnoses for this scenario, it does not mean it is complete. For example, if F=12 which is as the model predicts, GDE believes there is not symptom and therefore no diagnosis. However, following GDE's logic, {AB(M₁), AB(A₁)} should be a diagnosis, in which the faulty effects of M₁ and A₁ are cancelled out.

What makes Livingstone subject to improvement is that Livingstone only tracks several most possible diagnoses rather than all the diagnoses. Whereas GDE is good for other applications, GDE provides more than Livingstone really needs.

### SUMMARY OF THE INVENTION

According to the present invention, there is provided a method for obtaining a most likely diagnosis in a physical system having n components, a set of inputs, and a set of outputs, the method comprising steps of:

a) identifying a set of outputs G_{f} of the physical system that are not as predicted;

b) associating sets of involved components C_{f} with the set of outputs G_{f} of the physical system that are not as predicted;

c) removing from the set of outputs G_{f} of the physical system that are not as predicted any output which is associated with one component in the sets of involved components C_{f};

d) removing said one component from the sets of involved components C_{f};

e) identifying said one component as a diagnosis;

f) associating each remaining component in the sets of involved components C_{f} with a value indicative of a number of remaining outputs G_{f} of the physical system that are not as predicted;

g) removing a component that is associated with a highest value in step f);

h) identifying the component removed in step g) as a diagnosis;

i) removing from the set of outputs G_{f} of the physical system that are not as predicted any output which is associated with the component identified in step h); and if there remains any set of outputs G_{f} of the physical system that are not as predicted then return to step f).

Preferably, step g) further includes the step of randomly removing one among two or more components that are associated with a same value in step f).

According to another aspect of the present invention, there is provided a system for obtaining a most likely diagnosis in a physical system having n components, a set of inputs, and a set of outputs, the system comprising:

a) first identifying means for identifying a set of outputs G_{f} of the physical system that are not as predicted;

b) first associating means for associating sets of involved components C_{f} with the set of outputs G_{f} of the physical system that are not as predicted;

c) first removal means for removing from the set of outputs G_{f} of the physical system that are not as predicted any output which is associated with one component in the sets of involved components C_{f};

d) second removal means for removing said one component from the sets of involved components C_{f};

e) second identifying means for identifying said one component as a diagnosis;

f) second associating means for associating each remaining component in the sets of involved components C_{f} with a value indicative of a number of remaining outputs G_{f} of the physical system that are not as predicted;

g) third removal means for removing a component that is associated with a highest value;

h) third identifying means for identifying the component removed as a diagnosis;

i) fourth removal means for removing from the set of outputs G_{f} of the physical system that are not as predicted any output which is associated with the component identified by the third identifying means.

According to a preferred object of the present invention, there is provided a state-tracking algorithm based on set operations which reduces the memory requirement and increases the execution speed as compared to Livingstone.

According to another preferred object of the present invention, there is provided a method for finding the most probable diagnosis based on set operations and for fault probing which could further narrow down the diagnosis.

### BRIEF DESCRIPTION OF THE DRAWINGS

FIG. 1 is a block diagram of a known system consisting of three multipliers and two adders.

FIG. 2 is a block diagram of a system with one input, n components and one output.

FIG. 3 is a block diagram of a system with one input, four components and three outputs.

FIG. 4 is a block diagram of a system with six outputs.

FIG. 5 is a block diagram of a reduced architecture of a spacecraft propulsion system.

FIG. 6 is a block diagram of a valve system.

FIG. 7 is a block diagram of a system having two multipliers and an adder.

FIG. 8 is a block diagram of a preferred embodiment of a method according to the present invention.

### DETAILED DESCRIPTION OF THE INVENTION

A framework for system state identification is described below. The task is divided into two steps; the first step is the diagnosis stage which aims to find a set of all possible faulty components; the second step is the probing stage which aims to probe the most possible diagnoses among the set from the first step.

A. Diagnosis with Set Operations

According to the present invention, an inference engine is based on set operations. The theory behind this approach is supported by probability theory. A general approach is defined first and then a fine tuned consideration is discussed.

As defined herein, a supervised object is called a system. A system consists of components, inputs and outputs. The outputs are usually sensor data. Each output is defined as a function of inputs. The function can be continuous or discrete. The outputs are the results of the behaviors of some components of the system. The set of the involved components are called the Causal set (C-set) of an output. At the diagnosis stage, one does not need the detailed architectural model of components. In fact, Causal sets are simplified architectural models.

For example, referring back to FIG. 1, the system has five components, five inputs and two outputs. The functions that govern the components' behavior are: F=AC+BD, G=BD+CE. The C-set of the output F is {A₁, M₁, M₂}. The C-set of the output G is {A₂, M₂, M₃}. One makes the following assumption related to the C-set.

Assumption 1: Let C^{o}={C₁, C₂, . . . , Cₙ} be the C-set of the output O, where Cᵢ(i=1, 2, . . . , n) are components. One assumes: (∃XεC^{o} [symbol] AB(X))⇄AB(O) or equivalently OK(O)⇄(OK(X) for ∀XεC^{o}), where AB(X) represents that component X is faulty, OK(X) represents that component X is healthy (i.e. not faulty); AB(O) represents that output O is not as predicted and hence a symptom, OK(O) represents that output O is as predicted.

Essentially, one assumes that components' faults cannot be cancelled out. If the output is as predicted, then every component in the C-set is healthy. The assumption implies that all components in a C-set are healthy except when the output is not as predicted.

The diagnosis algorithm according to the present invention involves only set operations. Let G₀ be the set of all the outputs. Let C₀ be the corresponding C-sets of G₀ defined as

$${⋃}_{o ∈ {G}_{o}} {C}^{∘} ,$$

i.e. the union of all C-sets of outputs in G₀. In general, C₀ should be all the components of a system, otherwise, components not in Cₒ cannot be supervised. Gₒ is divided into two groups: G_{g} and G_{f}. G_{g} is the set of outputs that are as predicted. G_{f} is the set of outputs that are not as predicted. Let C_{g} be the corresponding C-sets of G_{g} and C_{f} be the corresponding C-sets of G_{f}. According to Assumption 1, all components C_{g} are good. Notice that C_{g} and C_{f} may intersect. Let C_{d}=C_{f}\C_{g}, then according to Assumption 1, C_{d} is the set of components that may be faulty. One calls C_{d} the candidate set of the diagnosis. It means any component in C_{d} can be faulty and components not in C_{d} are healthy. The candidate set is used to produce diagnoses but this diagnoses generation will be discussed after having given an example.

Referring back again to FIG. 1 as an example, the output set Gₒ={F, G} is divided into G_{f}={F} and G_{g}={G}. C_{f}={A₁, M₁, M₂}, C_{g}={A₂, M₂, M₃}, C_{d}={A₁, M₁}. The resulting candidate set is {A₁, M₁}. Without further information, one concludes that both M₁ and A₁ have the same probability to be faulty. It is also possible that both M₁ and A₁ fail simultaneously, though with much lower probability. One can immediately see the difference with GDE. GDE regards G as a symptom; however, following a causal relation G is not looked as a symptom in the present algorithm, and thus M₂ is exonerated. With this approach, the computational complexity is greatly reduced.

1. Diagnosis With Highest Probability

For generating diagnosis, one needs to make more assumptions.

Assumption 2: The probability of a component being faulty is very small.

Next there is provided some principles for generating diagnoses. The first principle is:
All other factors being equal, a diagnosis with small number of components is more likely than a diagnosis with large number of components.

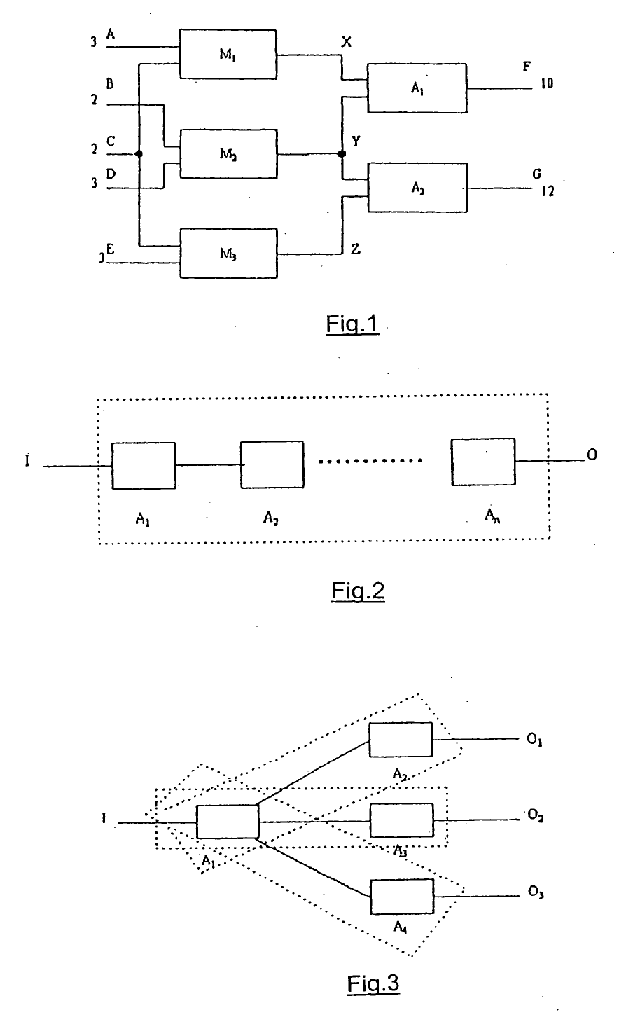

Referring to FIG. 2, there is shown a simple example to illustrate the above principle. In this system, there is only one input I, n components in total connected in series and only one output. The candidate set is {A₁, A₂, . . . , Aₙ}. In total, there are 2ⁿ−1 diagnoses. A diagnosis can consist of k (1≦k≦n) components.

Let's compute the probability of a diagnosis. One assumes that every component has the same probability of being faulty. Let p be the prior probability that a component is faulty. Given that the output is not as predicted, the probability that k (1≦k≦n) components are faulty (i.e. a diagnosis of k components) is

$$P ( k \vert AB ( O ) ) = \frac{P 〈 AB ( O ) \vert k 〉 P ( k )}{P ( AB ( O ) )} \qquad ( 1 )$$

Equation (1) is the Bayesian formula. P(AB(O)) is the normalizing constant and its value is irrelevant in the following computation. P(AB(O)|k) is the condition probability that the output is not as predicted given the k components are faulty. According to Assumption 1, P(AB(O)|k)=1. P(k) is the prior probability that k in n components are faulty. P(k)=p^{k}(1−p)^{n-k}. P(k|AB(O)) is proportional to P(k). For p<0.5, P(k₁)>P(k₂) for k₁<k₂. Let p=0.01, n=5, then P(1)=0.96059601×10⁻² and P(2)=0.970299×10⁻⁴. P(k) is about 100 times larger than P(k+1) and insensitive to n. Similarly P(k|AB(O)) is about 100 times larger than P(k+1|AB(O)) and insensitive to n.

The next principle is:
The more symptoms a component can explain, the more likely it is for the component to be faulty.

Referring to in FIG. 3, there is shown a simple system used as an example to support the principle above. Let's assume O₁, O₂ and O₃ are not as predicted. The candidate set is {A₁, A₂, A₃, A₄}. The diagnoses are {A₁}, {A₁, A₂}, {A₁, A₃}, {A₁, A₄}, {A₁, A₂, A₃}, {A₁, A₂, A₄}, {A₁, A₃, A₄}, {A₁, A₂, A₃, A₄} and {A₂, A₃, A₄}. It can be seen that A₁ is in all diagnosis but in {A₂, A₃, A₄}. Let's calculate the probability that A₁ is faulty, given O₁, O₂ and O₃ as symptoms. The probability is represented as P(AB(A₁)|{AB(O₁), AB(O₂), AB(O₃)}). Obviously, P(AB(A₁)|{AB(O), AB(O₂), AB(O₃)})>P({A₁}|{AB(O₁), AB(O₂), AB(O₃)}). The probability that A₁ is not faulty given O₁, O₂ and O₃ as symptoms is P(OK(A₁)|{AB(O₁), AB(O₂), AB(O₃)})=P({A₂, A₃, A₄}|{AB(O₁) AB(O₂), AB(O₃)}). Following the argument stated in the first principle, P({A₁}|AB(O₁ AB(O₂) AB(O₃)) is much larger than P({A₂, A₃, A₄}| AB(O₁) AB(O₂)AB(O₃)), given that the prior probability p is small. If p=0.01, then A₁ has about 10⁴ times possibility to be faulty than not. Similarly, A₁ has about 10² times more possibility to be faulty than any other component.

If the C-set of an output contains a single component, then the component being faulty explains the symptom of the output. This is obvious based on Assumption 1. Based on these principles (or assumptions), an algorithm for finding the most likely diagnosis is developed as follows:

Step 1: Given the C-set C_{f} associated with the symptoms G_{f}, remove from G_{f} any symptom which has a 1-component C-set, together with this component from C_{f}. This component is included in the diagnosis.

Step 2: Each component in the remainder of C_{f} is associated with a number which indicates the number of symptoms it can explain.

Step 3: Remove the component that has the highest number and include it in the diagnosis. Any tie is broken randomly. Remove the symptoms that the component can explain. If any symptoms exist then go to step 2 else stop.

Let m be the number of symptoms and n the number of components in the candidate set. The first iteration takes O(mn). After each iteration, the number of components and the number of symptoms are reduced at least by one. Therefore, the worst complexity is O(min{m,n}mn). It is a polynomial algorithm.

It is important to note that this algorithm does not guarantee the generation of minimal diagnosis. Nevertheless, it is the guideline for probing that is discussed further below.

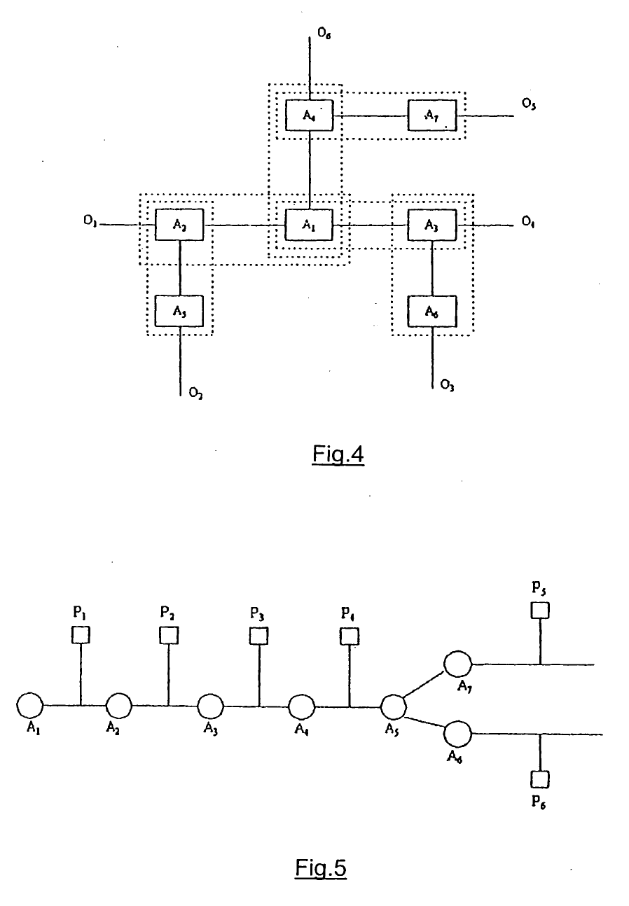

Referring to FIG. 4, there is shown a system used as an example that does not generate minimal diagnosis. Given that all outputs are symptoms, the diagnosis found by the present algorithm is {A₁, A₂, A₃, A₄} which is not minimal. In fact, {A₂, A₃, A₄} is also a diagnosis which is minimal.

2. Real Life Application

In a real life application, one expects the number of sensors to be (much) smaller than the number of components. If this is not the case, then there is redundancy in the sensor data in which case the redundant sensor data can be removed and therefore making the number of needed sensor data smaller or equal to the number of components. In general, one also expects the number of symptoms to be much smaller than the number of outputs. All these factors can reduce the computational time significantly.

Referring to FIG. 5, there is shown the architecture of a particular application, such as a reduced model of a spacecraft propulsion subsystem, which is used to simplify the general approach.

In this example, there could be any number of components between P₁, P₂, P₃, P₄, P₅ and P₆. However, for the diagnosis purpose, they are indistinguishable. In this case, they can be looked at as one single component.

With the reduced architecture, one can quickly identify the candidate set and the diagnoses. In the reduced architecture, the C-set of P₁ is {A₁}, the C-set of P₂ is {A₁ A₂}, etc. Let's assume one observes OK(P₁), OK(P₂), OK(P₃), AB(P₄), AB(P₅). For simplicity, one assumes sensors are fault free and AB(P₄) means there is zero pressure and hence no flow detected rather than other abnormalities. Then one can easily find the candidate set to be {A₄, A₅, A₇}. A₄ must be faulty, since A₄ is the only component in the candidate set that can explain AB(P₄) (or in logic terminology, AB(A₄) is consistent with AB(P₄)).

Referring back to FIG. 5, A₄ represents the components between P₃ and P₄, such as for example a set of check valves connected to a closed pyro (not shown). Assuming that the check valves cannot be reconfigured, then the first action for probing the propulsion subsystem is to fire the closed pyro between P₃ and P₄. If no changes are observed in P₄, then it is concluded that the check valves are faulty and the propulsion subsystem has then no means of solving the problem. If P₄ becomes OK(P₄), but AB(P₅) persists, then one repeats the diagnosis procedure. What has just been illustrated is not only the diagnosis process but also the probing process which is discussed next.

B. Fault Probing

Diagnosis does not stop in finding a candidate set or the most possible diagnosis. Means are provided for trying to find the exact faulty component(s). Otherwise, the previous section is all that can be achieved. For example, in FIG. 2, one cannot make further inference on the system.

Due to application constraints, it is assumed that one cannot make direct measurements inside a system. Sensor data are the only output data that can be measured. However, one can manipulate the inputs, change the behavior of some components and make inference from the relation between input changes and output changes. In spacecraft applications, fault probing can be achieved by issuing commands (i.e. input changes) and reconfiguring the system. In addition, in order to probe, one needs to rule out intermittent faults which may disappear or change their faulty behavior over time. In these cases, the faulty behavior does not need to be known a priori. Thus, the following assumptions are made:

Assumption 3: The number of sensors and their locations are fixed and known a priori. It is also not possible to make any direct probing of a component.

Assumption 4: A faulty component will remain faulty with the same faulty behavior during the probing time. The fault is persistent.

The general process of probing is to find the “defense witnesses” for suspected components or “witnesses for the prosecution” of abnormal components by manipulating inputs. This process is based on the structural and behavior model of the system. The probing process starts by choosing a strategy of changing inputs so that the new outputs can be used to help isolate the faulty component. There is provided two examples to explain the procedures.

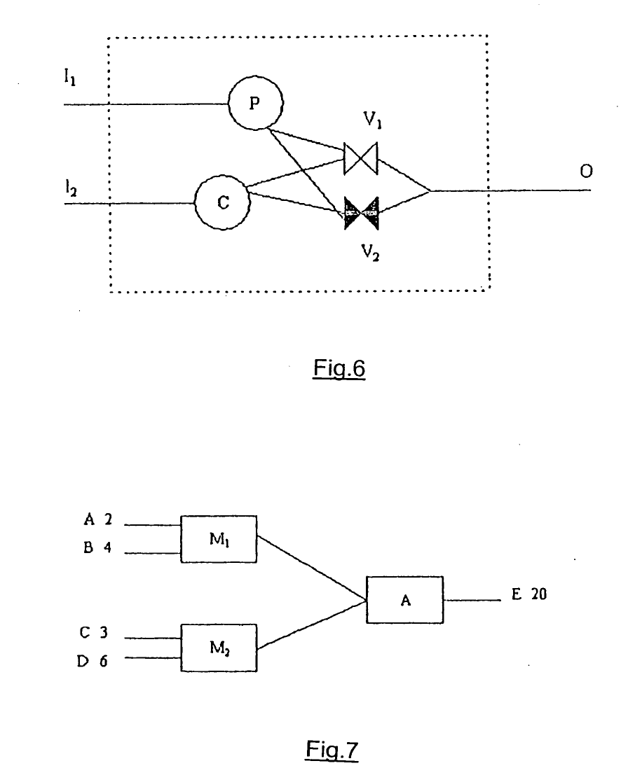

Referring to FIG. 6, there is shown a simple valve system. It consists of two valves: V₁ which is active and V₂ which is a backup of V₁. C is the controller of the two valves and P is the pump. I₁ and I₂ are the inputs which send commands to the pump and the controller respectively. O is the sensor output. Let's consider this scenario: P is commanded on, C is commanded on, V₁ is commanded open and the output O is observed to have no flow. Obviously, C, P and V₁ can be faulty. Due to real life constraints, one cannot make direct measurement as to which components are faulty. By further thought, the only action one can take to probe the system is to command open the valve V₂. Since this is the only action that can possibly modify the output and therefore provides information for fault isolation. If, as a result of this action, flow is observed in the output O, it is concluded that V₁ is faulty; otherwise, it is highly likely that either C or P is faulty, though V₁ is not exonerated (one assumes V₂ is not faulty).

The next example is a simple circuit shown in FIG. 7. M₁ and M₂ are multipliers and A is an adder. Let's have the inputs and output shown in FIG. 7. Obviously, E=20 is a symptom. The candidate set is {M₁, M₂, A}. Each component has equal probability of being faulty. There are two actions to take. The first one is to change either A or B and keep C and D unchanged; the second one is to change either C or D and keep A and B unchanged. Let's change A to 3. This change only affects the output of M₁ and A; it does not affect the output of M₂. One assumes {OK(M₁), OK(A), AB(M₂)}. Based on this assumption, one infers the faulty behavior of M₂ as F_{M}_{₂}(3, 6)=12. According to Assumption 4, this faulty behavior will not change with time. Therefore, when A is changed to 3, E is expected to be 24. If E is observed as 24, then the assumption of {OK(M₁), OK(A), AB(M₂)} will keep true. That means {AB(M₂)} is the final diagnosis. If E is not 24, then {OK(M₁), OK(A), AB(M₂)} is not true. No exact diagnosis can be obtained for this situation. More probing efforts are needed. Equipped with this example, it is not difficult to understand the following probing guideline:

Guideline: When there are multiple actions for probing, those that make the behavior of the most suspected components unchanged should be chosen first.

For example in FIG. 7, if M₁ has the highest probability of being faulty, action should be taken to either change C or D first.

The present approach belongs to model-based diagnosis. The algorithm according to the present invention depends on the knowledge of the structure and behavior model of a system. However, the method used for inferring diagnosis is different from the traditional approaches such as GDE or abductive approaches. Instead of purely using logic reasoning, one uses set operations for inference.

In summary, the FDI (fault diagnosis identification) procedure according to the present invention is divided into two steps: candidate set generation and probing. As seen, the computation complexity of candidate set generation is about linear with the number of component if the number of outputs (sensors) is a small constant. A method for finding the most likely diagnoses and a procedure for probing the diagnosis are proposed. The approach can find faults quickly and effectively. Though the diagnoses generated are not exhaustive and the inference is not complete, these are not to be considered as drawbacks, because no practical approach can achieve exhaustive diagnosis and complete inference.

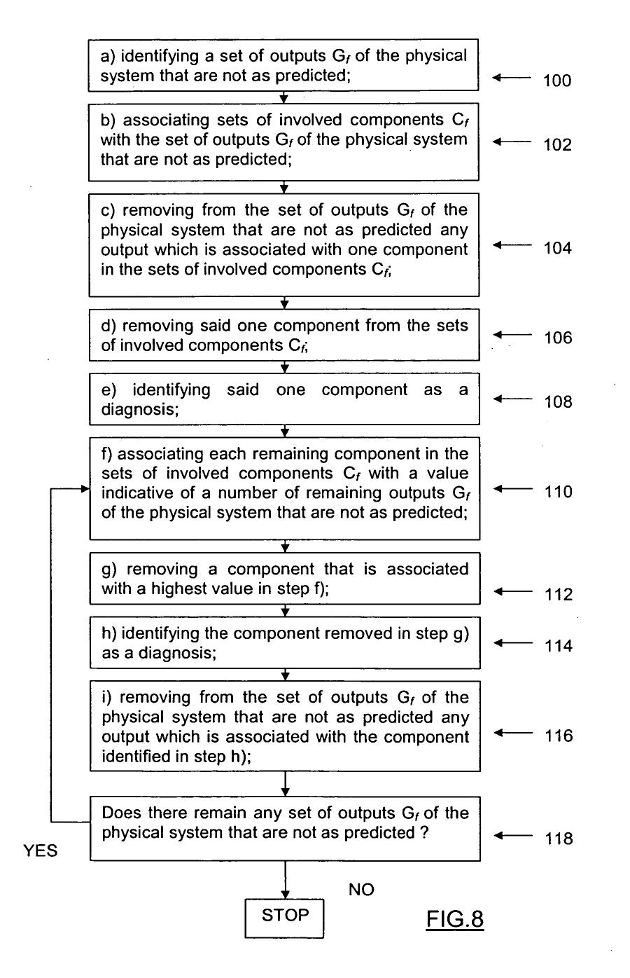

Referring to FIG. 8, there is shown a block diagram of the steps of a method for obtaining a most likely diagnosis in a physical system having n components, a set of inputs, and a set of outputs, according to a preferred embodiment of the present invention. The method includes the steps of:
a) identifying a set of outputs G_{f} of the physical system that are not as predicted, as shown by numeral 100;
b) associating sets of involved components C_{f} with the set of outputs G_{f} of the physical system that are not as predicted, as shown by numeral 102;
c) removing from the set of outputs G_{f} of the physical system that are not as predicted any output which is associated with one component in the sets of involved components C_{f}, as shown by numeral 104;
d) removing said one component from the sets of involved components C_{f}, as shown by numeral 106;
e) identifying said one component as a diagnosis, as shown by numeral 108;
f) associating each remaining component in the sets of involved components C_{f} with a value indicative of a number of remaining outputs G_{f} of the physical system that are not as predicted, as shown by numeral 110;
g) removing a component that is associated with a highest value in step f), as shown by numeral 112;
h) identifying the component removed in step g) as a diagnosis, as shown by numeral 114; and
i) removing from the set of outputs G_{f} of the physical system that are not as predicted any output which is associated with the component identified in step h), as shown by numeral 116.

And as shown by numeral 118, if there remains any set of outputs G_{f} of the physical system that are not as predicted then return to step f), if not then stop. A system according to the preferred embodiment of the invention take the form of a tool that basically operates according to the above method.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A method for obtaining a most likely diagnosis in a physical system having n components, a set of inputs, and a set of outputs, the method comprising steps of:
a) identifying a set of outputs G_{f} of the physical system that are not as predicted;
b) associating sets of involved components C_{f} with the set of outputs G_{f} of the physical system that are not as predicted;
c) removing from the set of outputs G_{f} of the physical system that are not as predicted any output which is associated with one component in the sets of involved components C_{f};
d) removing said one component from the sets of involved components C_{f};
e) identifying said one component as a diagnosis;
f) associating each remaining component in the sets of involved components C_{f} with a value indicative of a number of remaining outputs G_{f} of the physical system that are not as predicted;
g) removing a component that is associated with a highest value in step f);
h) identifying the component removed in step g) as a diagnosis;
i) removing from the set of outputs G_{f} of the physical system that are not as predicted any output which is associated with the component identified in step h); and if there remains any set of outputs G_{f} of the physical system that are not as predicted then return to step f).

2. The method according to claim 1, wherein step g) further includes the step of randomly removing one among two or more components that are associated with a same value in step f).

3. A system for obtaining a most likely diagnosis in a physical system having n components, a set of inputs, and a set of outputs, the system comprising:
a) first identifying means for identifying a set of outputs G_{f} of the physical system that are not as predicted;
b) first associating means for associating sets of involved components C_{f} with the set of outputs G_{f} of the physical system that are not as predicted;
c) first removal means for removing from the set of outputs G_{f} of the physical system that are not as predicted any output which is associated with one component in the sets of involved components C_{f};
d) second removal means for removing said one component from the sets of involved components C_{f};
e) second identifying means for identifying said one component as a diagnosis;
f) second associating means for associating each remaining component in the sets of involved components C_{f} with a value indicative of a number of remaining outputs G_{f} of the physical system that are not as predicted;
g) third removal means for removing a component that is associated with a highest value;
h) third identifying means for identifying the component removed as a diagnosis; and
i) fourth removal means for removing from the set of outputs G_{f} of the physical system that are not as predicted any output which is associated with the component identified by the third identifying means.
